(19) United States
(12) Patent Application Publication
(10) Pub. No.: US 2024/0078436 A1
(43) Pub. Date: Mar. 7, 2024

(54) METHOD AND APPARATUS FOR GENERATING TRAINING DATA FOR GRAPH NEURAL NETWORK

(71) Applicants: Robert Bosch GmbH, Stuttgart (DE); TSINGHUA UNIVERSITY, Beijing (CN)

(72) Inventors: Hang Su, Beijing (CN); Jun Zhu, Beijing (CN); Zhengyi Wang, Beijing (CN); Hao Yang, Shanghai (CN)

(21) Appl. No.: 18/259,563

(22) PCT Filed: Jan. 4, 2021
(86) PCT No.: PCT/CN2021/070124

§ 371 Date: Jun. 27, 2023

(51) Int. Cl. G06N 3/094

(52) U.S. Cl. CPC G06N 3/094

(57) ABSTRACT

A method for generating adversarial examples for a Graph Neural Network (GNN) model. The method includes: determining vulnerable features of target nodes in a graph based on querying the GNN model, wherein the graph comprising nodes including the target nodes and edges, each of the edges connecting two of the nodes; grouping the target nodes into a plurality of clusters according to the vulnerable features of the target nodes; and obtaining the adversarial examples based on the plurality of clusters.

### FIELD

Aspects of the present disclosure relate generally to artificial intelligence, and more particularly, to generating training data for a Graph Neural Network (GNN) model.

### BACKGROUND INFORMATION

Graph data has been widely used in many real-world applications, such as social networks, biological networks, citation networks, recommendation system, financial system, etc. Node classification is one of the most important tasks on graphs. The deep learning model for graph such as GNN model has achieved good results in the task of node classification on the graph. Given a graph with labels associated with a subset of nodes, the GNN model may predict the labels for the rest of the nodes.

Some studies have shown that certain techniques can be used to deceive the GNN model to wrongly classify nodes of a graph, such techniques may be referred to as adversarial attack. For example, a fraudulent user represented by a node in a financial network, a social network or the like may be classified by the GNN model as a highcredit user under the adversarial attack. The misclassification of the GNN model for a particular application may give chance to a malicious action.

Depending on the stages in which adversarial attacks happen, the adversarial attack may include evasion attack at the stage of model testing and poisoning attack at stage of model training. Poisoning attack tries to affect the performance of the model by adding adversarial samples into the training dataset.

Evasion attack only changes the testing data, which does not require to retrain the model.

Depending on the available information about the GNN model, the adversarial attack may include white-box attack, grey-box attack and black-box attack. In white-box attack, an attacker can get all information about the GNN model and use it to attack the system. The attack may not work if the attacker does not fully break the system first. In grey-box attack, an attacker can get limited information to attack the system.

Comparing to white-box attack, it is more dangerous to the system, since the attacker only need partial information. In black-box attack, an attacker can only do black-box queries on some of the samples. Thus, the attacker generally cannot do poisoning attack on the trained model and can only do evasion attack on the trained model. However, if black-box attack can work, it would be the most dangerous attack compared with the other two because it is more applicable in the real world situation.

There needs enhancement for improving the reliability of the GNN model against adversarial attack, especially black-box attack.

### SUMMARY

An effective way to improve the reliability of the GNN model against adversarial attack is to find adversarial examples for the GNN model and train the GNN model by using the adversarial examples.

If the adversarial examples for the GNN model may be found in a way that is more in line with a real situation, the GNN model trained with the adversarial examples will be of enhanced anti-attack ability and be more reliable in real situation.

According to an embodiment of the present invention, a method is provided for generating adversarial examples for a Graph Neural Network (GNN) model. The method comprises: determining vulnerable features of target nodes in a graph based on querying the GNN model, wherein the graph comprising nodes including the target nodes and edges, each of the edges connecting two of the nodes; grouping the target nodes into a plurality of clusters according to the vulnerable features of the target nodes; and obtaining the adversarial examples based on the plurality of clusters.

According to an embodiment of the present invention, a method is provided for training a GNN model. The method comprises: obtaining adversarial examples for the GNN model; setting a label for each of the adversarial examples; and training the GNN model by using the adversarial examples with the labels.

According to an embodiment of the present invention, a computer system is provided which comprises one or more processors and one or more storage devices storing computer- executable instructions that, when executed, cause the one or more processors to perform the operations of the method as mentioned above as well as to perform the operations of the method according to aspects of the present disclosure.

According to an embodiment of the present invention, one or more computer readable storage media are provided which store computer-executable instructions that, when executed, cause one or more processors to perform the operations of the method as mentioned above as well as to perform the operations of the method according to aspects of the present disclosure.

According to an embodiment of the present invention, a computer program product is provided comprising computer-executable instructions that, when executed, cause one or more processors to perform the operations of the method as mentioned above as well as to perform the operations of the method according to aspects of the present disclosure.

By generating the adversarial examples and using the adversarial examples to train the GNN model according to aspects of the present invention, the anti-attack ability of the GNN model may be improved against potential adversarial attack, particularly the most dangerous black box attack.

### BRIEF DESCRIPTION OF THE DRAWINGS

The disclosed aspects of the present invention will hereinafter be described in connection with the figures that are provided to illustrate and not to limit the disclosed aspects.

FIG. 1 illustrates an exemplary GCN model according to an embodiment of the present invention.

FIG. 2 illustrates an exemplary schematic diagram for influencing a classification task of a GCN model according to an embodiment of the present invention.

FIG. 3 illustrates an exemplary schematic process for generating adversarial examples according to an embodiment of the present invention.

FIG. 4 illustrates an exemplary process for obtaining MAF for a target node according to an embodiment of the present invention.

FIG. 5 illustrates an exemplary process for obtaining adversarial examples for a GCN model according to an embodiment of the present invention.

FIG. 6 illustrates an exemplary process for obtaining adversarial examples for a GCN model according to an embodiment of the present invention.

FIG. 7 illustrates an exemplary method for generating adversarial examples for a GNN model according to an embodiment of the present invention.

FIG. 8 illustrates an exemplary process for training a GNN model according to an embodiment of the present invention.

FIG. 9 illustrates an exemplary method for training a GNN model according to an embodiment of the present invention.

FIG. 10 illustrates an exemplary computing system according to an embodiment of the present invention.

### DETAILED DESCRIPTION OF EXAMPLE EMBODIMENTS

The present invention will now be discussed with reference to several example implementations. It is to be understood that these implementations are discussed only for enabling those skilled in the art to better understand and thus implement the embodiments of the present invention, rather than suggesting any limitations on the scope of the present invention.

Various embodiments will be described in detail with reference to the accompanying figures. Wherever possible, the same reference numbers will be used throughout the figures to refer to the same or like parts. References made to particular examples and embodiments are for illustrative purposes, and are not intended to limit the scope of the disclosure.

The present disclosure describes a method and a system according to the present invention, implemented as computer programs executed on one or more computers, which provides training data for improving reliability and robustness of a GNN model against adversarial attack thereon. As an example, the GNN model may be implemented as a graph convolution network (GCN) model, and may perform a machine learning task of classifying nodes in a graph, which may for example represents a social network, biological network, citation network, recommendation system, financial system, etc. The aspects of the disclosure may be applied in these fields such as the social network, biological network, citation network, recommendation system, financial system and so on to improve the security and robustness of these systems.

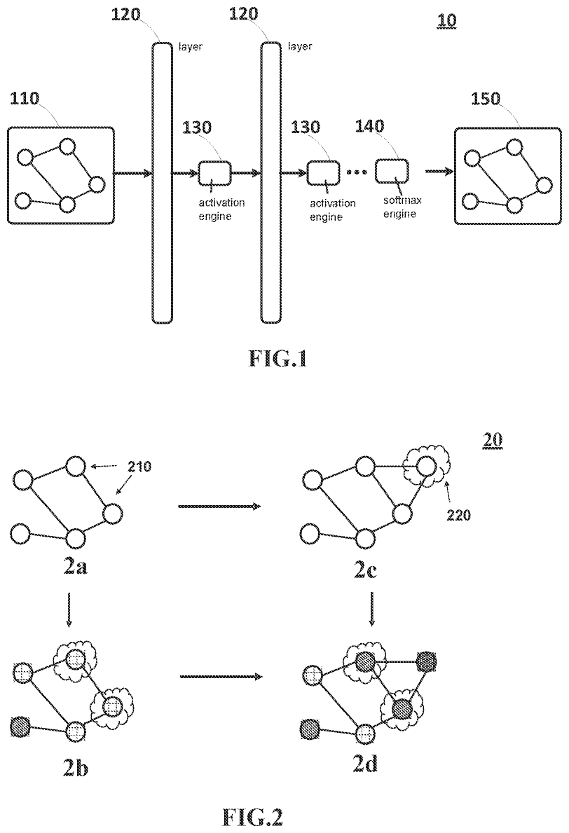

FIG. 1 illustrates an exemplary GCN model 10 according to an embodiment.

A graph is fed as input 110 of the GCN model 10. The graph may be a dataset that contains nodes and edges. The nodes in the graphs may represent entities, and the edges represent the connections between nodes. For example, a social network is a graph in which users or particularly user accounts in the network are nodes in the graph. An edge exists when two users are connected in some way. For example, the two users are friends, shares one's posts, have similar interests, have similar profiles, or the like, then the two users may have a connection which is represented by the edge.

In an example, the graph as the input 110 may be formulated as G=(A,X), where A ∈{0,1}^{N×N} represents the adjacency matrix of the graph G, X ∈{0,1}^{N×D} represents the feature matrix of the graph G, N is the number of nodes of graph G, D is the dimension of node feature. The adjacency matrix A may represent the connections among the nodes in the graph G, the feature matrix X may represent the features of respective nodes in the graph. The feature of a node may include multiple feature components, the number of which is defined as the dimension of the node feature. For example, for a graph of a social network, the feature components of a node may include age, gender, hobby, career, various actions such as shopping, reading, listening music, and so son. It is appreciated that aspects of the disclosure do not limited to specific values of the elements of the adjacency matrix and the feature matrix.

The GCN model 10 may include one or multiple hidden layers 120, which are also referred to as graph convolutional layers 120. Each hidden layer 120 may receive and process a graph-structured data. For example, the hidden layer 120 may perform convolution operation on the data. The weights of the convolution operations in the hidden layer 120 may be trained with training data. It is appreciated that other operations may be included in the hidden layer 120 in addition to the convolution operation. Each activation engine 130 may apply an activation function (e.g., ReLU) to the output from a hidden layer 120 and send the output to the next hidden layer 120. A fully-connected layer or a softmax engine 140 may provide an output 150 based on the output of the previous hidden layer. In the node classification task, the output 150 of the GCN model 10 may be classification labels or particularly classification probabilities for nodes in the graph.

The node classification task of the GCN model 10 is to determine the classification labels of nodes of the graph based on their neighbors. Particularly, given a subset of labeled nodes in the graph, the goal of the classification task of the GCN model 10 is to predict the labels of the remaining unlabeled nodes in the graph.

In an example, the GCN model 10 may be a two-layer GCN model as illustrated in equation (1):

f(G)=softmax(Âσ(ÂXW⁽⁰⁾)W⁽¹⁾) (1)

where

$$\hat{A} = {\hat{D}}^{\frac{1}{2}} ( A + I ) {\hat{D}}^{- \frac{1}{2}}$$

is a normalized adjacency matrix, \hat{D} is a degree matrix of adjacency matrix A with \hat{D}ᵢᵢ=Σⱼ(A+I)ᵢⱼ, W⁽⁰⁾ ∈ [symbol] ^{D×D}^{_{H}} and W⁽¹⁾ ∈ [symbol] ^{D}^{_{H}}^{×D}^{_{L}} are parameter matrices of two hidden layers 120, where D_{H} denotes the dimension of the hidden layer, D_{L} denotes the number of the categories of the classification labels, and σ(x) is the activation function 130, for example, σ(x)=ReLU(x). f(G) ∈ [symbol] ^{N×D}^{_{L}} is the output matrix 150, representing the probability of each node to each classification label in the graph.

FIG. 2 illustrates an exemplary schematic diagram 20 for influencing a classification task of a GCN model according to an embodiment.

Taking the graph G=A, X) as shown in FIG. 2a as example, the nodes 210 may be target nodes, for which the classification results of the GCN model 10 is to be manipulated or influenced.

As shown in FIG. 2b, a fake node 220 with corresponding fake features is introduced to the graph by connecting to the target nodes 210, leading to a modified graph G⁺=(A⁺,X⁺)) to change the predicted labels of target nodes 210 by the GCN model 10.

It is appreciated that multiple fake nodes may be added to the graph as perturbation although only one fake node is illustrated. The adjacency matrix of the modified graph G⁺ becomes

$${A}^{+} = [ \begin{matrix}A & {B}^{T} \\ B & {A}_{fake}\end{matrix} ]$$

and the feature matrix becomes

$${X}^{+} = [ \begin{matrix}x \\ {x}_{fake}\end{matrix} ] ,$$

where A is the original adjacency matrix of the graph G shown in FIG. 2a, A_{fake} is the adjacency matrix of the fake nodes, matrix B and its transposed matrix B^{T} represent the connections between the original nodes and the fake nodes, X is the original feature matrix of the graph G, X_{fake} is the feature matrix of the fake nodes. By means of manipulating A_{fake}, B, X_{fake}, especially the feature matrix X_{fake} of the fake nodes, the GCN model's classification result on target nodes may be manipulated or influenced.

As illustrated in FIGS. 2c and 2d, the target nodes 210 which should have been classified as a first label by the GCN model 10 may be misclassified as a second label due to the perturbation of the fake node 220.

The feature matrix X_{fake} of the fake nodes may be derived based on the output 150 of the GCN model 10 as a black box in response to queries. In real world situation, it may be not available to perform a large number of queries, and it may be not available to have a large number of fake nodes available. It would be more in line with the real world situation if less number of queries to the GCN model are performed and more target nodes are manipulated with less fake nodes during obtaining the fake nodes. Accordingly the GCN model trained with the obtained adversarial examples may be more robust in real situation.

FIG. 3 illustrates an exemplary schematic process 30 for generating adversarial examples according to an embodiment.

Given target nodes 310 of a graph G shown in FIG. 3a, vulnerable features 320 of the target nodes 310 may be determined based on querying the GNN model 10, as illustrated in FIG. 3b. The vulnerable feature 320 of a target node may be referred to as most adversarial feature (MAF), which is related to the target node's gradient towards an adversarial example. Then the target nodes 310 may be grouped into a plurality of clusters 330 and 335 according to the vulnerable features 320 of the target nodes 310, as illustrated in FIG. 3c. And the adversarial examples 340 and 345 may be obtained based on the plurality of clusters 330 and 335 as illustrated in FIG. 3d.

By connecting the adversarial examples 340 and 345 respectively to the target nodes of the clusters 330 and 335 as illustrated in FIG. 3d, the GCN model's classification on the target nodes of the clusters 330 and 335 may be changed. And if the GCN model is further trained with the adversarial examples 340 and 345, which is for example labeled as a malicious node, the GCN model may be more capable to combat the similar adversarial attack.

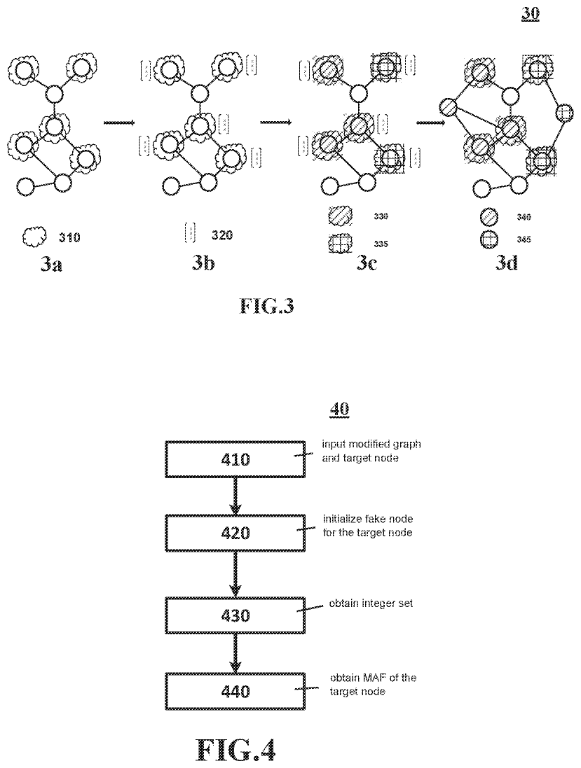

FIG. 4 illustrates an exemplary process 40 for obtaining MAF for a target node according to an embodiment.

The MAF of a target node represents the vulnerability of the target node. In order to obtain the MAF of a target node, a loss function may be optimized as equation (2):

$$\begin{matrix}{min}_{{A}_{fake} , B , {X}_{fake}} 𝕃 ( {G}^{+} ; {Φ}_{A} ) & s . t . {‖ B ‖}_{0} \leq \end{matrix} {Δ}_{edge} , r ( {A}_{fake} ) = {N}_{fake} \qquad Eq . ( 2 )$$

where

$${G}^{+} = ( [ \begin{matrix}A & {B}^{T} \\ B & {A}_{fake}\end{matrix} ] , [ \begin{matrix}X \\ {X}_{fake}\end{matrix} ] ) ,$$

Φ_{A} represents the targets nodes, r(A_{fake}) is the number of rows of matrix A_{fake}, which is equal to the number N_{fake} of fake nodes, the number of fake nodes introduced to the original graph may be limited with this parameter. The 1⁰-norm ∥·∥0 represents the number of non-zero elements. The acronym “s.t.” stands for “subject to”. The smaller value of the loss function indicates more target nodes are misclassified. The loss function may be defined as equation (3):

$$𝕃 ( {G}^{+} ; {Φ}_{A} ) = {\sum }_{v ∈ {Φ}_{A}} \sqrt{ℓ ( G + , v )} \qquad Eq . ( 3 )$$

where [symbol] (G⁺,v) ≥0 represents loss function for a target node v. Smaller [symbol] (G⁺, v) means node v is more likely to be misclassified by target model such as the modefshown in equation (1) and node v is successfully misclassified by target model f when [symbol] (G⁺, v) equals to zero. In equation (3), \sqrt{⋅} is used to reward the nodes which are likely to be misclassified, and the loss values [symbol] (G⁺, v) for all target nodes v ∈Φ_{A} are summed to represent how close the model is to misclassify all the target nodes. The loss function [symbol] (G⁺, v) for one target node v may be defined in equation (4) or (5),

$$ℓ ( {G}^{+} , v ) = max ( {[ f ( {G}^{+} ) ]}_{v , {y}_{g}} - {max}_{{y}_{i} \neq {y}_{g}} ( {[ f ( {G}^{+} ) ]}_{v , {y}_{i}} ) , 0 ) \qquad Eq . ( 4 )$$

where y_{g} stands for the ground truth label of the node v and [f(G⁺)]_{v,yi}, which may be obtained by querying the GCN model, represents the predicted probability of node v to have classification label yᵢ by GCN model f When [symbol] (G⁺, v) equals to zero, it means the ground truth label y_{g} is misclassified as another label yᵢ. The smaller the loss value [symbol] (G⁺, v) is, the more possible the target node v is misclassified.

$${ℓ ( {G}^{+} , v ) = max ( {max}_{{y}_{i} \neq {y}_{t}} ( f ( {G}^{+} ) ]}_{v , {y}_{i} )} - {[ f ( {G}^{+} ) ]}_{v , {y}_{t}} , 0 ) \qquad Eq . ( 5 )$$

where yₜ stands for the target classification label of node v. When [symbol] (G⁺, v) equals to zero, it means the node v is misclassified as label yₜ by the GCN model.

At step 410, a modified graph G⁺=(A⁺,X⁺)) and a target node vt may be taken as an input of the process 40.

At step 420, one fake node v_{f} may be initialized for the target node vₜ. Particularly, the feature (i.e., feature vector including feature components) of the fake node v_{f} may be randomly initialized, and the fake node v_{f} may be connected to the target node vₜ while the other fake nodes being isolated from the graph. The isolation of the other fake nodes may be performed by setting the elements corresponding to the other fake nodes in matrices A_{fake} and B to zero. The connection of fake node v_{f} and the target node vₜ may be performed by setting the element corresponding to the connection of the both in matrices B to one.

At step 430, an integer set I ⊆ {1 ,2, . . . , D} subject to |I|=min (Kₜ, D)may be obtained, for example, may be randomly obtained by randomly picking the elements from the integer set {1,2, . . . , D}. D is the dimension of feature or feature vector for each node of the graphs. Kₜ is the predefined number of queries. By defining the |I|=min (Kₜ, D), the number of queries to the GCN model may be controlled so as to bring limited perturbation to the original graph.

At step 440, the MAF of the target node vₜ may be obtained based on querying the model with the modified graph for a number of times. At each time of querying, a feature component of the fake node v_{f} may be modified, and the loss value of the target node may be calculated based on a loss function, for example, the loss function of equation (3), (4) or (5). If the loss value resulted from the modified feature component of the fake node v_{f} becomes smaller than the previous loss value, the feature component of the fake node V_{f} is updated to the modified value, otherwise, the feature component of the fake node V_{f} is maintained as the value before the modification. The resulting feature of the fake node v_{f} including the update feature components after the queries may be taken as the MAF of the target node vₜ.

The process of obtaining the MAF of the target node vₜ may be illustrated as the following pseudocode:

```
for i ϵ I do
  if x_{f}(i) ← 1 − x_{f}(i) makes [symbol] (G⁺, Φ_{A}) smaller then
    x_{f}(i) ← 1 − x_{f}(i)
  end if
end for
return MAF(vₜ) ← x_{f}
```

where I is the integer set randomly obtained in step 430, and x_{f}(i) is the ith feature component of the fake node.

It is appreciated that the specific elements in the equations and the operations in the process of obtaining the MAF of the target node vt may be modified under the spirit of aspects of the disclosure, and thus would not limit the scope of the disclosure. For example, the reward \sqrt{⋅} may be not necessary in the equation (3). For another example, although there may be |I| times of queries occurs in the process of the above exemplary pseudocode, there may be total |I| or |I|+1 times of queries occurs depending on whether a query for the randomly initialized feature vector X_{f} of the fake node v_{f} is performed. For example, in the case no query is performed for the randomly initialized feature vector X_{f}, the loss function corresponding to it may be set to an experienced value.

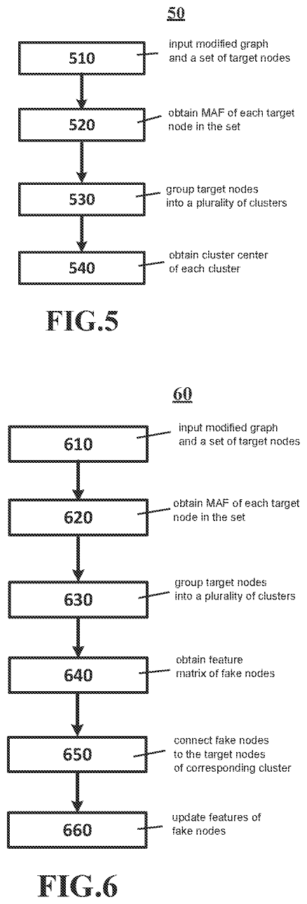

FIG. 5 illustrates an exemplary process 50 for obtaining adversarial examples for a GCN model according to an embodiment.

At step 510, a modified graph G⁺=(A⁺, X⁺) and a set of target nodes Φ_{A} may be taken as an input of the process 50. In an example, the matrix

$${A}^{+} = [ \begin{matrix}A & 0 \\ 0 & 0\end{matrix} ]$$

may be initially set, and the feature matrix X_{fake} of fake nodes may be randomly initialized.

At step 520, the MAF of each target node vt in the set Φ_{A} may be obtained based on querying the GCN model. For example, the process shown in FIG. 4 may be used to obtain the MAF of each target node vₜ in the set Φ_{A}.

At step 530, the target nodes Φ_{A} may be grouped into a plurality of clusters according their MAFs. The number of the clusters may be equal to the number of fake nodes N_{fake}.

In an adversarial scenario, it's often the case that the number of fake nodes allowed to add to the graph is much smaller than the number of target nodes. To influence more target nodes with limited number of fake nodes, every fake node may be connected to multiple target nodes.

Due to the structural complexity of the graph, different target nodes may have different local structures and the corresponding feature information, especially when the target nodes are sparsely scattered in the whole graph. Consequently, the target nodes may have very behaviors under influence from adversarial examples. A fake node with certain feature may change the predicted label of one target node after connecting to it, but may not change another target node's label. Based on the above perspective, if a fake node is connected to multiple target nodes which share a similarity that their predicted labels are all easily changed after they are connected to fake nodes with similar features, then it would be of bigger probability to change the predicted labels of those target nodes. Therefore, the target nodes may be grouped into a plurality of clusters according to the similarity of the their MAFs.

In order to divide the target nodes Φ_{A} into N_{fake} clusters C={C₁, C₂, . . . , C_{N}_{_{fake}}} according to their MAFs, an object function of clustering is defined in equation (6)

$$\begin{matrix}{min}_{C} {\sum }_{{C}_{i} ∈ C} {\sum }_{v ∈ {C}_{i}} {‖ MAF ( v ) - {c}_{i} ‖}_{2}^{2} & s . t . {⋃}_{{C}_{i} ∈ C} {C}_{i} = {Φ}_{A}\end{matrix} \qquad Eq . ( 6 )$$

where ∥⋅∥₂ denotes l²-norm,

$${c}_{i} = \frac{1}{\vert {c}_{i} \vert} {\sum }_{v ∈ {C}_{i}} MAF ( v )$$

represents the cluster center of each cluster Cᵢ, for example, the cᵢ may be the average of the MAFs of the target nodes in the cluster Cᵢ.

The optimization of the clustering objection function of equation (6) can be solved by any cluster algorithm, so as to obtain the clusters C={C₁, C₂, . . . , C_{N}_{_{fake}}}, that minimize the clustering object function shown in equation (6).

At step 540, after obtaining the clusters C={C₁, C₂, . . . , C_{N}_{_{fake}}}, the cluster center cᵢ of each cluster Cᵢ, that is, the average of the MAFs of the target nodes in the cluster Cᵢ, may be obtained. Then the cluster center of the MAFs of the target nodes in each cluster is taken as the corresponding fake node's feature, as illustrated in equation (7):

x_{fi}=cᵢ p Eq. (7)

where x_{fi} is the feature of the ith fake node v_{fi} corresponding to the cluster Cᵢ. In an example, the elements of the feature vector x_{fi} of the fake node v_{fi} corresponding to the cluster Cᵢ may be rounded to nearest integer. Then the adversarial examples having the features x_{fi} are obtained.

FIG. 6 illustrates an exemplary process 60 for obtaining adversarial examples for a GCN model according to an embodiment.

Steps 610 to 640 are same as steps 510 to 540 shown in FIG. 5, and thus would not be described in detail.

At step 640, the feature matrix X_{fake} of the N_{fake} fake nodes are obtained using equation (7), where x_{fi} are vectors in X_{fake}.

At step 650, each of the fake nodes may be connected to the target nodes of a corresponding cluster so that the graph is modified by adding edges among the fake nodes and the target nodes. The connection of each fake node to the corresponding cluster may be performed by setting the matrix B, as shown in equation (8):

$${B}_{ij} = \{ \begin{matrix}1 , & if {v}_{j} ∈ {C}_{i} \\ 0 , & otherwise\end{matrix} \qquad Eq . ( 8 )$$

where Bᵢⱼ represents the element of matrix B at row i and column j.

At step 660, the features of the fake nodes obtained at step 640 may be updated based on querying the GNN model with the modified graph, so as to enhance the features of the fake nodes.

In an example, for each fake node v_{fi}, an integer set I ⊆{1,2, . . . , D} subject to |I|=min (K_{f}, D) may be randomly obtained by randomly picking the elements from the integer set {1,2, . . . , D}. D is the dimension of feature or feature vector for each node of the graphs. K_{f} is the predefined number of queries. By defining the |I|=min (K_{f}, D), the number of queries to the GCN model may be controlled so as to bring limited perturbation to the original graph. Then the feature components of the fake node v_{fi} may be updated based on querying the model with the modified graph for a number of times. At each time of querying, a feature component of the fake node v_{fi} may be modified, and the loss value of the fake node may be calculated based on a loss function, for example, the loss function of equation (3). If the loss value resulted from the modified feature component of the fake node v_{fi} becomes smaller than the previous loss value, the feature component of the fake node v_{fi} is updated to the modified value, otherwise, the feature component of the fake node v_{fi} is maintained as the value before the modification. The resulting feature of the fake node v_{fi} including the updated feature components after the |I| times of queries may be the enhanced feature of the fake node v_{fi}.

The process of obtaining the updated features of the fake nodes, i.e., the feature matrix X_{fake} of the N_{fake} fake nodes, may be illustrated as the following pseudocode:
Initialize X_{fake} using Eq. (7) with elements therein rounding to nearest integer.

```
for i = 1,2, ...,N_{fake} do
  Randomly sample I ⊆ {1, 2, ... , D} subject to |I| = min (K_{f},D).
  for j ϵI do
    if x_{fi}(j) ← 1 − x_{fi}(j) makes [symbol] (G⁺; Φ_{A}) smaller then
      x_{fi} (j) ← 1 − x_{fi}(j)
    end if
  end for
end for
return X_{fake}
```

where x_{fi}(j) is the jth feature component of the fake node x_{fi}.

It is appreciated that the specific elements in the equations and the operations in the process of updating the features of the fake nodes may be modified under the spirit of aspects of the disclosure, and thus would not limit the scope of the disclosure. For example, the reward \sqrt{⋅} may be not necessary in the equation (3). For another example, although there may be |I| times of queries occurs for each fake node in the process of the above exemplary pseudocode, there may be total |I| or |I|+1 times of queries occurs for each fake node depending on whether there is a query for the original feature vector x_{fi} of the fake node v_{fi}. For example, in the case no query is performed for the original feature vector xhd fi, the loss function corresponding to it may be set to an experienced value.

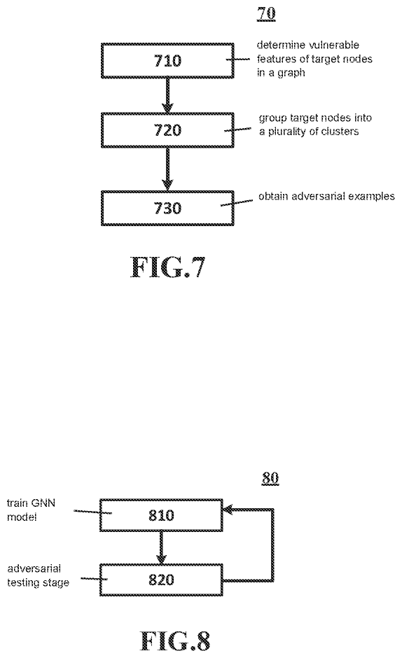

FIG. 7 illustrates an exemplary method 70 for generating adversarial examples for a GNN model according to an embodiment.

At step 710, vulnerable features of target nodes in a graph are determined based on querying the GNN model, wherein the graph comprises nodes including the target nodes and edges, each of the edges connecting two of the nodes.

At step 720, the target nodes are grouped into a plurality of clusters according to the vulnerable features of the target nodes.

At step 730, the adversarial examples are obtained based on the plurality of clusters.

In an embodiment, in step 730, for each of the plurality of clusters, a feature of a corresponding one of the adversarial examples is obtained by averaging the vulnerable features of the target nodes in the cluster.

In an embodiment, in step 730, for each of the plurality of clusters, an initial feature of a corresponding one of the adversarial examples is obtained based on the vulnerable features of the target nodes in the cluster, the graph is modified by connecting each of the adversarial examples having the initial features to the target nodes in a corresponding one of the plurality of clusters, and the features of the adversarial examples are updated based on querying the GNN model with the modified graph.

In an embodiment, in step 710, the querying the GNN model comprises querying the GNN model with modified graphs which are obtained by adding a fake node to the graph.

In an embodiment, in step 710, for each of the target nodes in the graph, a modified graph is obtained by connecting one fake node to the target node in the graph, the vulnerable feature of the target node is determined based on querying the GNN model with the modified graph.

In an embodiment, in step 710, for each of a plurality of feature components of the fake node, the feature component of the fake node is modified, the GNN model is queried with the modified graph having the modified feature component of the fake node, and the feature component of the fake node is updated based on result of the querying, wherein the feature of the fake node including the updated feature components being taken as the vulnerable feature of the target node.

In an embodiment, in step 710, in the update of the feature component of the fake node based on result of the querying, the feature component of the fake node is changed to the modified feature component if the modified feature component leads to a smaller loss value according to a loss function, the feature component of the fake node is maintained if the modified feature component does not lead to a smaller loss value according to the loss function.

In an embodiment, in step 710, the number of times of said querying for the plurality of feature components of the fake node equals to a smaller one of a predefined value and a feature dimension of a node in the graph.

In an embodiment, in step 720, the target nodes are grouped into the plurality of clusters according to similarity of vulnerable features of target nodes in each of the clusters.

In an embodiment, in step 720, the target nodes are grouped into the plurality of clusters by solving a minimization of a clustering object function for the vulnerable features of target nodes.

In an embodiment, in step 730, for each of the plurality of clusters, an initial feature of a corresponding one of a plurality of fake nodes is obtained based on the vulnerable features of the target nodes in the cluster, the graph is modified by connecting each of the plurality of fake nodes having the initial features to the target nodes in a corresponding one of the plurality of clusters, and the feature of each of the plurality of fake nodes is updated based on querying the GNN model with the modified graph.

In an embodiment, in step 730, in the update of the feature of each of the plurality of fake nodes based on querying the GNN model with the modified graph, for each of a plurality of feature components of the fake node, the feature component of the fake node is modified, the GNN model is queried with the modified graph having the modified feature component of the fake node, the feature component of the fake node is updated based on result of the querying, wherein the fake nodes with the feature including the updated feature components being taken as the obtained adversarial examples.

In an embodiment, in step 730, in the update of the feature component of the fake node based on result of the querying, the feature component of the fake node is changed to the modified feature component if the modified feature component leads to a smaller loss value according to a loss function, and the feature component of the fake node is maintained if the modified feature component does not lead to a smaller loss value according to the loss function.

FIG. 8 illustrates an exemplary process 80 for training a GNN model according to an embodiment.

At the training stage 810, a GNN model such as a GCN model may be trained with a training data set.

At the adversarial testing stage 820, adversarial examples for the GNN mode trained at stage 810 may be generated by using the method as described above with reference to FIGS. 1 to 7.

Then the adversarial examples generated at 820 may be used to further train the GNN model at 810. The process of training 810 and adversarial testing 820 may be repeated to obtained a reliable GNN model.

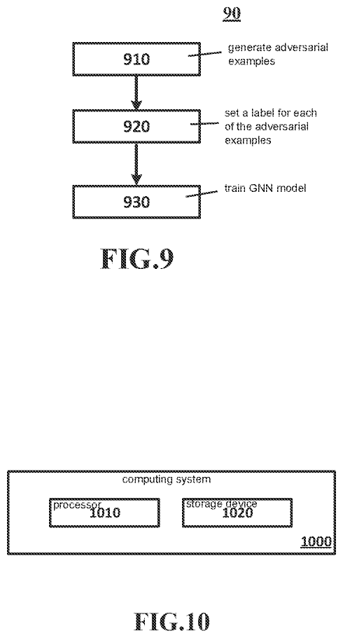

FIG. 9 illustrates an exemplary method for training a GNN model according to an embodiment.

At step 910, adversarial examples for a GNN model may be generated by using the method as described above with reference to FIGS. 4 to 7.

At step 920, a label may be set for each of the adversarial examples. For example, the label may be set as a malicious label.

At step 930, the GNN model is trained by using the adversarial examples with the labels.

FIG. 10 illustrates an exemplary computing system 1000 according to an embodiment. The computing system 1000 may comprise at least one processor 1010. The computing system 1000 may further comprise at least one storage device 1020. The storage device 1020 may store computer-executable instructions that, when executed, cause the processor 1010 to determine vulnerable features of target nodes in a graph based on querying the GNN model, wherein the graph comprising nodes including the target nodes and edges, each of the edges connecting two of the nodes; group the target nodes into a plurality of clusters according to the vulnerable features of the target nodes; and obtain the adversarial examples based on the plurality of clusters.

It should be appreciated that the storage device 1020 may store computer- executable instructions that, when executed, cause the processor 1010 to perform any operations according to the embodiments of the present disclosure as described in connection with FIGS. 1-9.

The embodiments of the present disclosure may be embodied in a computer-readable medium such as non-transitory computer-readable medium. The non-transitory computer-readable medium may comprise instructions that, when executed, cause one or more processors to perform any operations according to the embodiments of the present disclosure as described in connection with FIGS. 1-9.

The embodiments of the present disclosure may be embodied in a computer program product comprising computer-executable instructions that, when executed, cause one or more processors to perform any operations according to the embodiments of the present disclosure as described in connection with FIGS. 1-9.

It should be appreciated that all the operations in the methods described above are merely exemplary, and the present disclosure is not limited to any operations in the methods or sequence orders of these operations, and should cover all other equivalents under the same or similar concepts.

It should also be appreciated that all the modules in the apparatuses described above may be implemented in various approaches. These modules may be implemented as hardware, software, or a combination thereof. Moreover, any of these modules may be further functionally divided into sub-modules or combined together.

The above description is provided to enable any person skilled in the art to practice the various aspects described herein. Various modifications to these aspects will be readily apparent to those skilled in the art, and the generic principles defined herein may be applied to other aspects. Thus, the present invention is not intended to be limited to the aspects shown herein. All structural and functional equivalents to the elements of the various aspects described throughout the present disclosure that are known or later come to be known to those of ordinary skill in the art are expressly incorporated herein by reference and are intended to be encompassed herein.

1-20 (canceled)

21. A method for generating adversarial examples for a Graph Neural Network (GNN) model, comprising the following steps:
determining vulnerable features of target nodes in a graph based on querying the GNN model, wherein the graph includes nodes including the target nodes and edges, each of the edges connecting two of the nodes;
grouping the target nodes into a plurality of clusters according to the vulnerable features of the target nodes; and
obtaining the adversarial examples based on the plurality of clusters.

22. The method of claim 21, wherein the obtaining of the adversarial examples based on the plurality of clusters includes:
for each cluster of the plurality of clusters, obtaining a feature of a corresponding one of the adversarial examples by averaging the vulnerable features of the target nodes in the cluster.

23. The method of claim 21, wherein the obtaining of the adversarial examples based on the plurality of clusters comprising:
for each cluster of the plurality of clusters, obtaining an initial feature of a corresponding one of the adversarial examples based on the vulnerable features of the target nodes in the cluster;
modifying the graph by connecting each of the adversarial examples having the initial features to the target nodes in a corresponding one of the plurality of clusters; and
updating the features of the adversarial examples based on querying the GNN model with the modified graph.

24. The method of claim 21, wherein the querying of the GNN model includes querying the GNN model with modified graphs which are obtained by adding a fake node to the graph.

25. The method of claim 24, wherein the determining of the vulnerable features of target nodes in the graph based on querying of the GNN model includes:
for each target node of the target nodes in the graph: obtaining a modified graph by connecting one fake node to the target node in the graph, and determining the vulnerable feature of the target node based on querying the GNN model with the modified graph.

26. The method of claim 25, wherein the determining of the vulnerable feature of the target node based on the querying of the GNN model with the modified graph includes:
for each of a plurality of feature components of the fake node: modifying the feature component of the fake node, querying the GNN model with the modified graph having the modified feature component of the fake node, and updating the feature component of the fake node based on a result of the querying, wherein the feature of the fake node includes the updated feature components being taken as the vulnerable feature of the target node.

27. The method of claim 26, wherein the updating of the feature component of the fake node based on the result of the querying includes:
changing the feature component of the fake node to the modified feature component when the modified feature component leads to a smaller loss value according to a loss function;
maintaining the feature component of the fake node when the modified feature component does not lead to a smaller loss value according to the loss function.

28. The method of claim 26, wherein s number of times of the querying for the plurality of feature components of the fake node equals to a smaller one of a predefined value and a feature dimension of a node in the graph.

29. The method of claim 21, wherein the grouping of the target nodes into the plurality of clusters includes: grouping the target nodes into the plurality of clusters according to similarity of vulnerable features of target nodes in each of the clusters.

30. The method of claim 29, wherein the grouping of the target nodes into the plurality of clusters includes: grouping the target nodes into the plurality of clusters by solving a minimization of an object function of clustering for the vulnerable features of target nodes.

31. The method of claim 25, wherein the obtaining of the adversarial examples based on the plurality of clusters includes:
for each of the plurality of clusters, obtaining an initial feature of a corresponding one of a plurality of fake nodes based on the vulnerable features of the target nodes in the cluster;
modifying the graph by connecting each of the plurality of fake nodes having the initial features to the target nodes in a corresponding one of the plurality of clusters; and
updating the feature of each of the plurality of fake nodes based on querying the GNN model with the modified graph.

32. The method of claim 31, wherein the updating of the feature of each of the plurality of fake nodes based on querying the GNN model with the modified graph includes:
for each of a plurality of feature components of the fake node: modifying the feature component of the fake node, querying the GNN model with the modified graph having the modified feature component of the fake node, and updating the feature component of the fake node based on result of the querying, wherein the fake nodes with the feature including the updated feature components being taken as the obtained adversarial examples.

33. The method of claim 32, wherein the updating of the feature component of the fake node based on result of the querying includes:
changing the feature component of the fake node to the modified feature component when the modified feature component leads to a smaller loss value according to a loss function;
maintaining the feature component of the fake node when the modified feature component does not lead to a smaller loss value according to the loss function.

34. The method of claim 21, further comprising setting a label for each of the adversarial examples.

35. The method of claim 21, wherein the GNN model is a Graph Convolutional Network (GCN) model.

36. The method of claim 21, wherein the graph represents a social network or a citation network or a financial network.

37. A method for training a Graph Neural Network (GNN) model, comprising:
obtaining adversarial examples for the GNN model by:
determining vulnerable features of target nodes in a graph based on querying the GNN model, wherein the graph includes nodes including the target nodes and edges, each of the edges connecting two of the nodes,
grouping the target nodes into a plurality of clusters according to the vulnerable features of the target nodes, and
obtaining the adversarial examples based on the plurality of clusters;
setting a label for each of the adversarial examples; and
training the GNN model by using the adversarial examples with the labels.

38. A computer system, comprising:
one or more processors; and
one or more storage devices storing computer-executable instructions for generating adversarial examples for a Graph Neural Network (GNN) model, the instructions, when executed by the one or more processors cause the one or more processors to perform the following steps:
determining vulnerable features of target nodes in a graph based on querying the GNN model, wherein the graph includes nodes including the target nodes and edges, each of the edges connecting two of the nodes,
grouping the target nodes into a plurality of clusters according to the vulnerable features of the target nodes, and
obtaining the adversarial examples based on the plurality of clusters.

39. One or more non-transitory computer readable storage media on which are stored computer-executable instructions executable instructions for generating adversarial examples for a Graph Neural Network (GNN) model, the instructions, when executed by one or more processors cause the one or more processors to perform the following steps:
determining vulnerable features of target nodes in a graph based on querying the GNN model, wherein the graph includes nodes including the target nodes and edges, each of the edges connecting two of the nodes,
grouping the target nodes into a plurality of clusters according to the vulnerable features of the target nodes, and
obtaining the adversarial examples based on the plurality of clusters.
